(19) United States
(12) Patent Application Publication
(10) Pub. No.: US 2025/0282269 A1
(43) Pub. Date: Sep. 11, 2025

(54) CUSHION BODY

(71) Applicant: TOYOTA BOSHOKU KABUSHIKI KAISHA, Aichi-ken (JP)

(72) Inventors: Hirokazu YONEMARU, Nagoya-shi (JP); Tomohiko INOUE, Ichinomiya-shi (JP)

(73) Assignee: TOYOTA BOSHOKU KABUSHIKI KAISHA, Aichi-ken (JP)

(21) Appl. No.: 19/066,528

(22) Filed: Feb. 28, 2025

(30) Foreign Application Priority Data
Mar. 8, 2024 (JP) 2024-035491

(51) Int. Cl. B60N 2/58; B60N 2/42

(52) U.S. Cl. CPC B60N 2/5825; B60N 2/4263

(57) ABSTRACT

A cushion body includes a seat pad and a seat cover that covers the seat pad. The cushion body includes a fastening groove that is formed on a pad back surface of the seat pad, and a fastener that is sewn to an end of the seat cover and that is press-fitted into the fastening groove. A groove wall of the fastening groove includes a protruding groove wall that protrudes so as to form a press-fit surface of the fastener, and a recessed groove wall that is aligned with the protruding groove wall in a groove length direction and that is recessed so as to avoid abutting against the fastener.

### CROSS-REFERENCE TO RELATED APPLICATION

The present invention is based upon and claims the benefit of a priority to Japanese Patent Application No. 2024-035491, filed on Mar. 8, 2023, the entire contents of which are incorporated herein by reference.

### TECHNICAL FIELD

The present invention relates to a cushion body. More specifically, the present invention relates to a cushion body including a seat pad and a seat cover that covers the seat pad.

### BACKGROUND ART

JP2015-2780A discloses a structure for fixing the end of a seat cover to a hard pad back surface of a seat pad. Specifically, an arrowhead-shaped barbed fastener is sewn to the end of the seat cover. The seat cover is fixed to the pad back surface by press-fitting the fastener at the end of the seat cover into a fastening groove formed on the pad back surface of the seat pad.

### SUMMARY OF INVENTION

In the configuration described in JP2015-2780A, since the fastener has a long configuration extending along the end of the seat cover, there is a matter in that the press-fit load on the fastening groove becomes high. Therefore, the present invention provides a cushion body capable of appropriately reducing a press-fit load for fixing the end of a seat cover to the pad back surface of a seat pad.

To solve the above matters, a cushion body according to the present invention is implemented as follows.

In a first aspect of the present invention, a cushion body includes a seat pad and a seat cover that covers the seat pad. The cushion body includes a fastening groove that is formed on a pad back surface of the seat pad, and a fastener that is sewn to an end of the seat cover and that is press-fitted into the fastening groove. In the cushion body, a groove wall of the fastening groove includes a protruding groove wall that protrudes so as to form a press-fit surface of the fastener, and a recessed groove wall that is aligned with the protruding groove wall in a groove length direction and that is recessed so as to avoid abutting against the fastener.

According to the first aspect of the present invention, when the fastener is press-fitted into the fastening groove, the fastener is press-fitted by abutting only against the protruding groove wall without abutting against the recessed groove wall. As a result, the contact area of the fastener with the groove wall is reduced, and the press-fit load is reduced.

In a second aspect of the present invention, a plurality of the protruding groove walls are provided in the groove length direction.

According to the second aspect of the present invention, the fastener abuts against the protruding groove wall at a plurality of locations in the groove length direction. As a result, the fastener abuts against the protruding groove wall so as not to be inclined in the fastening groove, and the assembling property and the holding property after assembly is appropriately improved.

In a third aspect of the present invention, the protruding groove walls are provided on both of the groove walls of the fastening groove.

According to the third aspect of the present invention, the fastener is partially abut against the groove walls. As a result, the press-fitting load of the fastener is more appropriately reduced.

In a forth aspect of the present invention, the protruding groove walls are provided at facing positions of both of the groove walls.

According to the fourth aspect of the present invention, the fastener can be held so as to be disposed between the protruding groove walls located at the facing positions of both of the groove walls. Accordingly, the fastener can be held so as not to be inclined in the fastening groove.

In a fifth aspect of the present invention, the protruding groove walls provided on both of the groove walls do not overlap each other in the groove length direction.

According to the fifth aspect of the present invention, since the protruding groove walls do not face each other, a wide space into which the fastener can be press-fitted can be secured between each protruding groove wall and the opposing groove wall. Accordingly, the assembling property of the fastener can be improved.

In a sixth aspect of the present invention, a cross-sectional width of the fastener press-fitted into the fastening groove is larger than a minimum groove width for press-fitting that is reduced by a protrusion of the protruding groove wall of the fastening groove, and is smaller than a maximum groove width that is increased by a recess of the recessed groove wall.

According to the sixth aspect of the present invention, the press-fit load can be reduced by appropriately avoiding abutting against the recessed groove wall while appropriately ensuring the engagement allowance of the fastener with the protruding groove wall.

In a seventh aspect of the present invention, the fastener includes, along a press-fitting direction, a plurality of arrowhead-shaped barbs that are hooked on the protruding groove wall by press-fitting into the fastening groove.

According to the seventh aspect of the present invention, the press-fit load of the fastener can be reduced while the fastener is appropriately fixed in the fastening groove in a state in which the fastener is prevented from coming off.

### BRIEF DESCRIPTION OF DRAWINGS

FIG. 1 is a perspective view showing the schematic configuration of a cushion body according to a first embodiment;

FIG. 2 is a perspective view showing a state before a fastener is press-fitted into a fastening groove;

FIG. 3 is a bottom view of the fastening groove as viewed from the pad back side;

FIG. 4 is a bottom view corresponding to FIG. 3, showing a state in which the fastener is press-fitted into the fastening groove;

FIG. 5 is a cross-sectional view taken along a line V-V in FIG. 4;

FIG. 6 is a bottom view showing the schematic configuration of a cushion body according to a second embodiment;

FIG. 7 is a bottom view showing the schematic configuration of a cushion body according to a third embodiment; and

FIG. 8 is a bottom view showing the schematic configuration of a cushion body according to a fourth embodiment.

### DESCRIPTION OF EMBODIMENTS

Hereinafter, embodiments of the present invention will be described with reference to the drawings.

### First Embodiment

### Schematic Configuration of Cushion Body 1

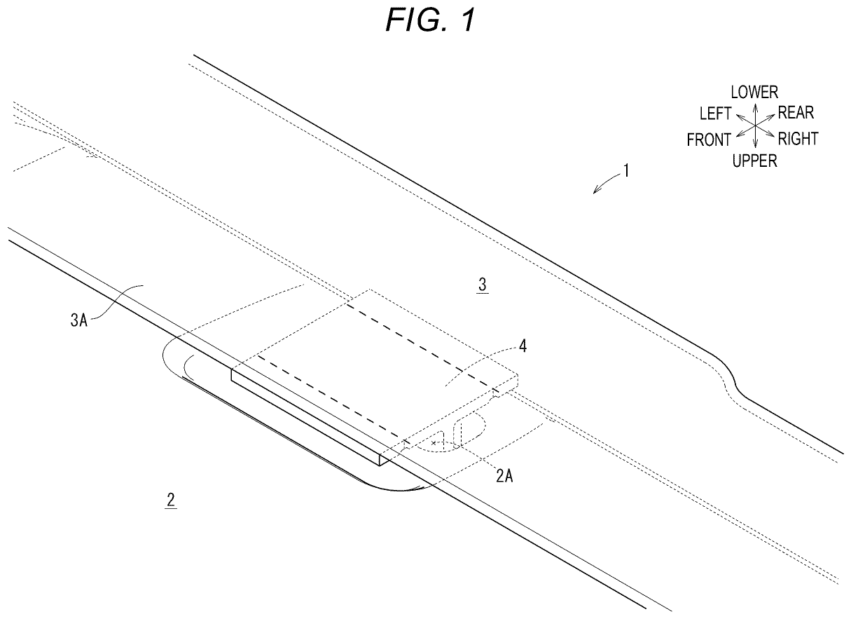

First, the configuration of a cushion body 1 according to a first embodiment of the present invention will be described with reference to FIGS. 1 to 5. In the following description, when a direction such as front, rear, upper, lower, left, or right is described, it is assumed that the direction indicates a corresponding direction shown in the drawings. In addition, in the following description, when a specific reference diagram is not described or when there is no corresponding reference numeral in the reference diagram, any one of FIGS. 1 to 5 is referred to as appropriate.

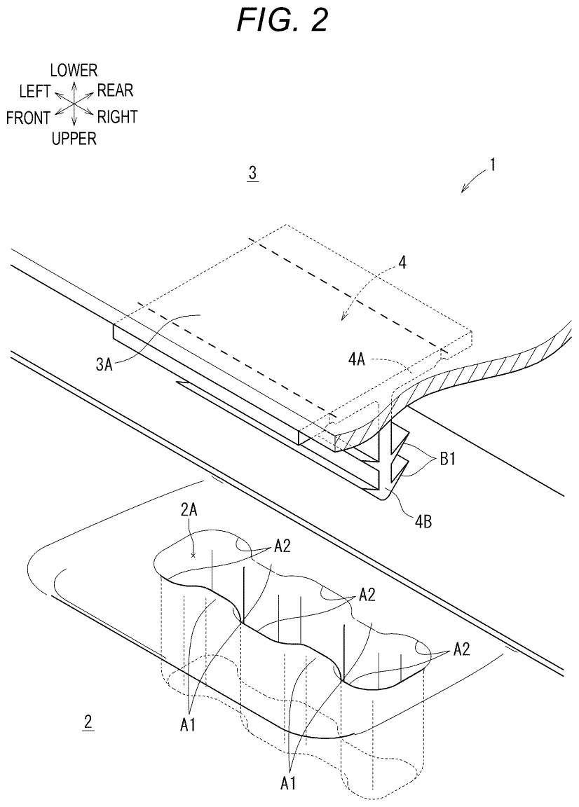

As shown in FIGS. 1 and 2, the cushion body 1 according to the present embodiment is applied to a seat cushion that forms the seating portion of an automobile seat. The cushion body 1 includes a seat pad 2 made of a foamed resin material, and a fabric seat cover 3 that covers the seat pad 2.

The seat cover 3 covers the seat pad 2 from the pad front surface side. Front, rear, left, and right ends 3A of the seat cover 3 are pulled into the pad back side, and are fixed to corresponding fastening grooves 2A formed on the pad back surface of the seat pad 2. FIGS. 1 to 2 show the seat pad 2 as viewed from the pad back side.

In the seat pad 2, the pad surface portion that supports the buttocks and thighs of the seated person is made of polyurethane foam. The pad back portion that constitutes the pad back surface of the seat pad 2 is made of polypropylene foam, which is harder than polyurethane foam.

The seat pad 2 has such a configuration and the buttocks and thighs of the seated person can be softly supported on the soft pad front portion. The seat pad 2 receives the load applied by the seated person in a widely distributed manner with the hard pad back portion.

The seat pad 2 has an uneven shape (not shown) formed on the hard pad back portion, which prevents the buttocks of the seated person from sinking and sliding forward during a vehicle collision, known as the submarine phenomenon. The fastening groove 2A extends in a striped manner in such a hard pad back portion.

As shown in FIG. 2, each end 3A of the seat cover 3 is fixed by press-fitting a resin fastener 4 sewn to the end 3A into the corresponding fastening groove 2A from the pad back side. Each fastener 4 is formed of a plate-shaped member extending along a respective one of the ends 3A of the seat cover 3.

Specifically, the fastener 4 is formed of a plate-shaped member having a T-shaped cross section and including a long plate-shaped sewn portion 4A that is placed against the end 3A of the seat cover 3 and that is sewn thereto, and a long plate-shaped press-fit portion 4B that extends to rise from the center of the sewn portion 4A and that is configured to be press-fitted into the fastening groove 2A.

The distal end portion and the intermediate portion of the press-fit portion 4B are formed with arrowhead-shaped barbs B1 for improving hooking into the fastening grooves 2A after press-fitting. The barbs B1 protrude symmetrically and obliquely in the directions from the press-fit portion 4B so as to hook onto both of groove walls of the fastening grooves 2A. The barbs B1 protrude from the press-fit portion 4B in the same shape. The fasteners 4 extend with a uniform cross-sectional shape in the longitudinal direction (the groove length direction).

Each of the fastening grooves 2A is implemented such that the corresponding fastener 4 can be press-fitted into the fastening groove 2A from the pad back side, thereby fixing the fastener 4 in a state in which the fastener 4 is prevented from coming off. Each of the fastening grooves 2A is implemented such that even if the seat pad 2 having the groove wall is made of a hard polypropylene foam, the corresponding fastener 4 can be press-fitted with a relatively small force.

The configuration of the fastening grooves 2A and the fasteners 4 press-fitted into the fastening grooves 2A will be described in detail below, taking the configuration of one set shown in FIG. 2 as an example. The other sets of the fastening grooves 2A and the fasteners 4 have the same configuration.

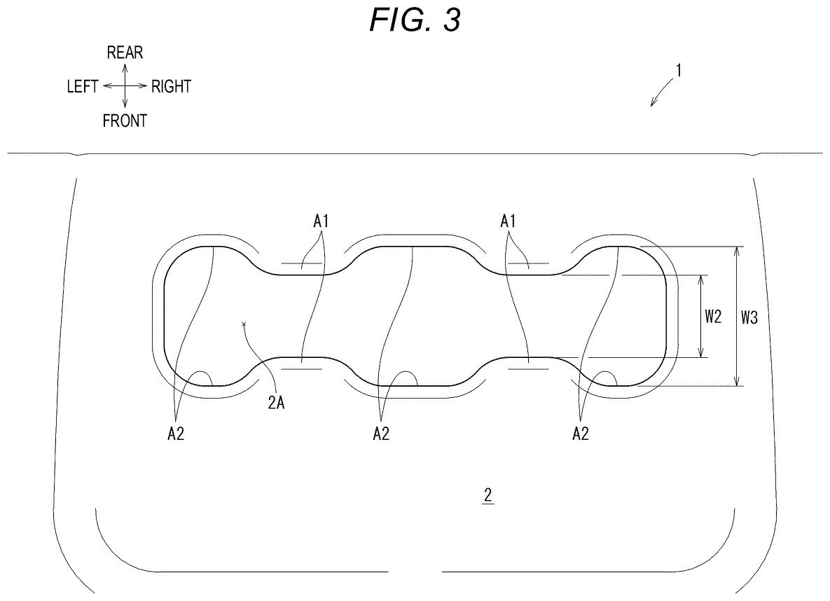

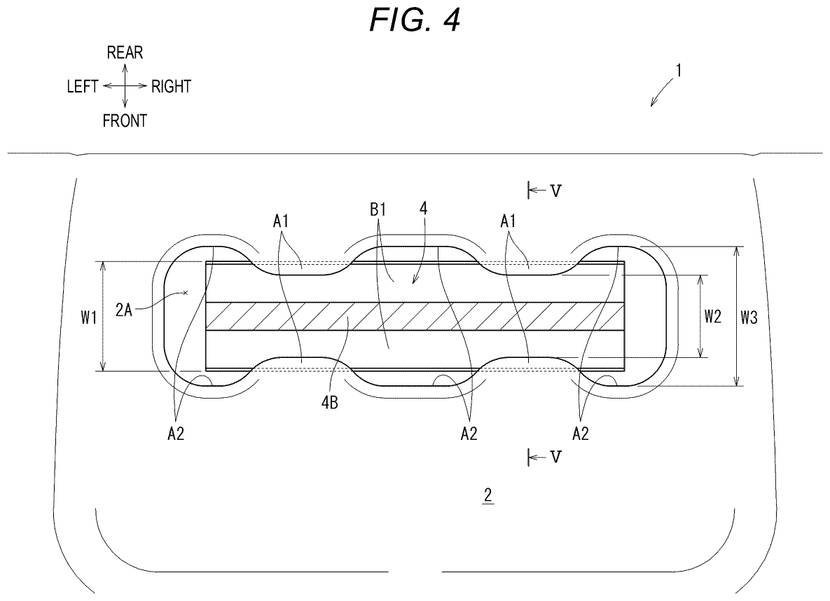

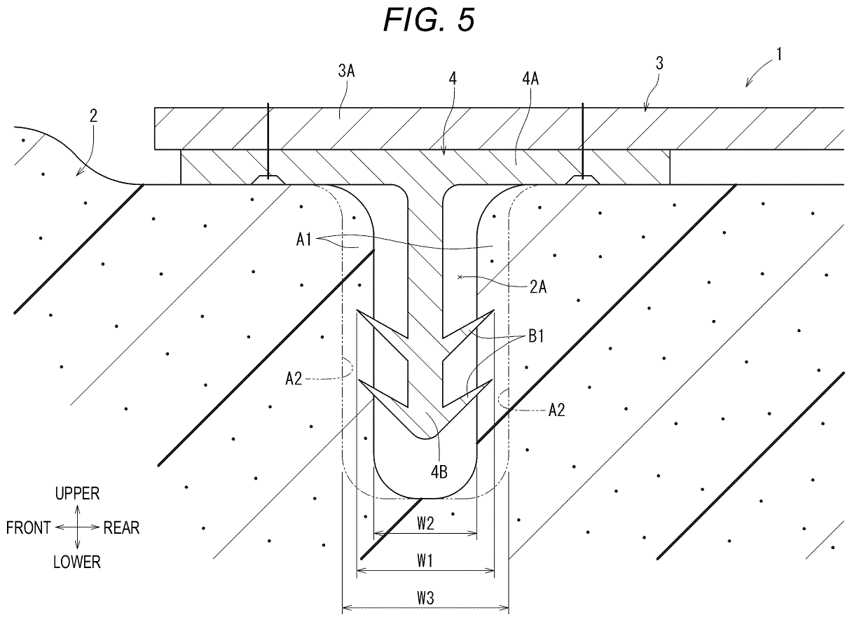

As shown in FIG. 3, the fastening groove 2A does not have a flat groove wall extending in the groove length direction, but is formed in an uneven shape with bank-shaped protruding groove walls A1 protruding here and there. As shown in FIGS. 4 and 5, these protruding groove walls A1 are portions that form a press-fitting surface when the fastener 4 is press-fitted.

As shown in FIG. 3, the fastening groove 2A is formed as a recessed groove wall A2 in which the other groove walls are relatively recessed with respect to the protruding groove walls A1 due to formation of the protruding groove walls A1. The recessed groove walls A2 are formed in the groove walls of the fastening groove 2A so as to form flat surfaces that extend flush with each other in the groove length direction.

The protruding groove walls A1 protrude from the recessed groove walls A2 in the same shape. Each of the protruding groove walls A1 is formed in a horizontally elongated shape such that the protruding width in the groove length direction is greater than the protruding length. As shown in FIG. 2, each of the protruding groove walls A1 has a uniform cross-sectional shape over substantially the entire region in the groove depth direction of the fastening groove 2A.

As shown in FIG. 3, specifically, a total of four protruding groove walls A1 are formed on each groove wall of the fastening groove 2A at two positions in the groove length direction. In each groove wall of the fastening groove 2A, two protruding groove walls A1 that are aligned in the groove length direction are spaced apart from each other in the groove length direction. The protruding groove walls A1 formed in the groove walls of the fastening groove 2A face each other in the groove width direction.

A minimum groove width W2, which is the dimension between the protruding groove walls A1 facing each other in the groove width direction, is smaller than the dimension between the two distal ends of the barbs B1, which is a maximum cross-sectional width W1 of the press-fit portion 4B of the fastener 4 shown in FIGS. 4 to 5. As shown in FIG. 4, a maximum groove width W3, which is the dimension between the recessed groove walls A2 facing each other in the groove width direction and formed in the groove walls of the fastening groove 2A, is larger than the cross-sectional width W1 of the fastener 4 described above. The plate thickness of the press-fit portion 4B of the fastener 4 is smaller than the minimum groove width W2 described above.

With this configuration, the press-fit portion 4B of the fastener 4 is inserted into the fastening groove 2A, so that the barbs B1 of the fastener 4 are pressed against the inner surfaces of the protruding groove walls A1. Then, as shown in FIG. 5, the press-fit portion 4B of the fastener 4 is pressed into the groove, and the fastener 4 is press-fitted into the groove along the inner surfaces of the protruding groove walls A1 while the barbs B1 are elastically compressed by coming into contact with the inner surfaces of the protruding groove walls A1.

The press-fit portion 4B of the fastener 4 is press-fitted into the fastening groove 2A to a position where the sewn portion 4A of the fastener 4 is pressed against the pad back surface of the seat pad 2. Accordingly, the fastener 4 is fixed in a state in which the barbs B1 are hooked on the inner surfaces of the protruding groove walls A1 and act as a wedge to restrict movement in the removal direction with respect to the fastening groove 2A. As a result, the end 3A of the seat cover 3 sewn to the fastener 4 is fixed to the pad back surface of the seat pad 2.

As shown in FIG. 4, more specifically, the fastener 4 is held in a state in which two portions in the groove length direction are pressed and sandwiched in the groove width direction by the four protruding groove walls A1 described above. Accordingly, the fastener 4 is held so as not to incline in the fastening groove 2A in the groove width direction.

The fastener 4 comes into contact with only the protruding groove walls A1 formed in portions of the groove walls of the fastening groove 2A, and does not come into contact with the recessed groove walls A2. Therefore, the fastener 4 can be press-fitted into the fastening groove 2A with a small press-fit load, as compared with a configuration with a large contact area in which the fastener 4 comes into contact with the groove walls of the fastening groove 2A over the entire region in the groove length direction. Further, after the fastener 4 is press-fitted, the fastener 4 is appropriately held in place by the wedging action of hooking of the two barbs B1, so that the fastener 4 is not pulled out of the fastening groove 2A due to the tension of the seat cover 3.

To summarize the above, the cushion body 1 according to the present embodiment may have the following configuration. In the following description, the reference numerals assigned in parentheses correspond to the configurations described in the embodiment described above.

That is, a cushion body (1) includes a seat pad (2), and a seat cover (3) that covers the seat pad (2). The cushion body (1) includes a fastening groove (2A) that is formed on a pad back surface of the seat pad (2), and a fastener (4) that is sewn to an end (3A) of the seat cover (3) and that is press-fitted into the fastening groove (2A). A groove wall of the fastening groove (2A) includes a protruding groove wall (A1) that protrudes so as to form a press-fit surface of the fastener (4), and a recessed groove wall (A2) that is aligned with the protruding groove wall (A1) in a groove length direction and that is recessed so as to avoid abutting against the fastener (4).

According to the configuration described above, when the fastener (4) is press-fitted into the fastening groove (2A), the fastener (4) can be press-fitted by abutting only against the protruding groove wall (A1) without abutting against the recessed groove wall (A2). As a result, the contact area of the fastener (4) with the groove wall can be reduced, and the press-fit load can be reduced.

A plurality of the protruding groove walls (A1) are provided in the groove length direction. According to the configuration described above, the fastener (4) can abut against the protruding groove wall (A1) at a plurality of locations in the groove length direction. As a result, the fastener (4) can abut against the protruding groove wall (A1) so as not to be inclined in the fastening groove (2A), and the assembling property and the holding property after assembly can be appropriately improved.

The protruding groove walls (A1) are provided on both of the groove walls of the fastening groove (2A). According to the configuration described above, the fastener (4) can partially abut against the groove walls. As a result, the press-fit load of the fastener (4) can be more appropriately reduced.

The protruding groove walls (A1) are provided at facing positions of both of the groove walls. According to the configuration described above, the fastener (4) can be held so as to be disposed between the protruding groove walls (A1) located at the facing positions of both of the groove walls. Accordingly, the fastener (4) can be held so as not to be inclined in the fastening groove (2A).

A cross-sectional width (W1) of the fastener (4) press-fitted into the fastening groove (2A) is larger than a minimum groove width (W2) for press-fitting that is reduced by a protrusion of the protruding groove wall (A1) of the fastening groove (2A), and is smaller than a maximum groove width (W3) that is increased by a recess of the recessed groove wall (A2). According to the configuration described above, the press-fit load can be reduced by appropriately avoiding abutting against the recessed groove wall (A2) while appropriately ensuring the engagement allowance of the fastener (4) with the protruding groove wall (A1).

The fastener (4) includes, in a press-fitting direction, a plurality of arrowhead-shaped barbs (B1) that are hooked on the protruding groove wall (A1) by press-fitting into the fastening groove (2A). According to the configuration described above, the press-fit load of the fastener (4) can be reduced while the fastener (4) is appropriately fixed in the fastening groove (2A) in a state in which the fastener (4) is prevented from coming off.

### Second Embodiment

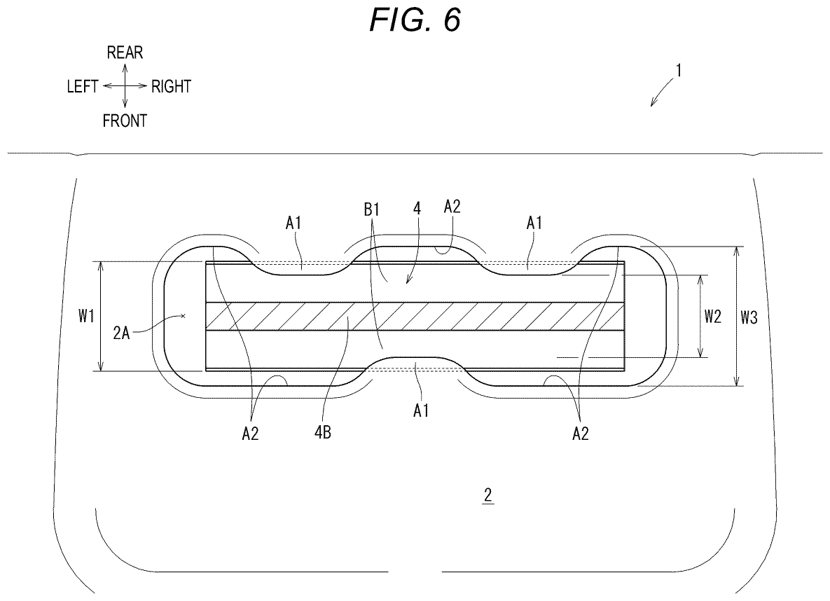

Next, the configuration of the cushion body 1 according to a second embodiment of the present invention will be described with reference to FIG. 6. In the present embodiment, a total of three protruding groove walls A1 are formed on the groove walls of the fastening groove 2A.

Specifically, two protruding groove walls A1 are formed in one groove wall of the fastening groove 2A so as to be aligned in the groove length direction. One protruding groove wall A1 is formed on the other groove wall. The one protruding groove wall A1 is located between two protruding groove walls A1 formed on the opposing groove wall in the groove length direction. Specifically, two protruding groove walls A1 formed on one groove wall and one protruding groove wall A1 formed on the other groove wall do not overlap each other in the groove length direction.

In this way, the protruding groove walls A1 do not face each other in the groove width direction, so that a wide space into which the fastener 4 can be press-fitted can be secured between each protruding groove wall A1 and the opposing groove wall (the recessed groove wall A2). Therefore, the assembling property of the fastener 4 can be improved. Since the configurations other than the above are the same as the configuration disclosed in the first embodiment, the same reference numerals are given and the detailed description thereof is omitted.

### Third Embodiment

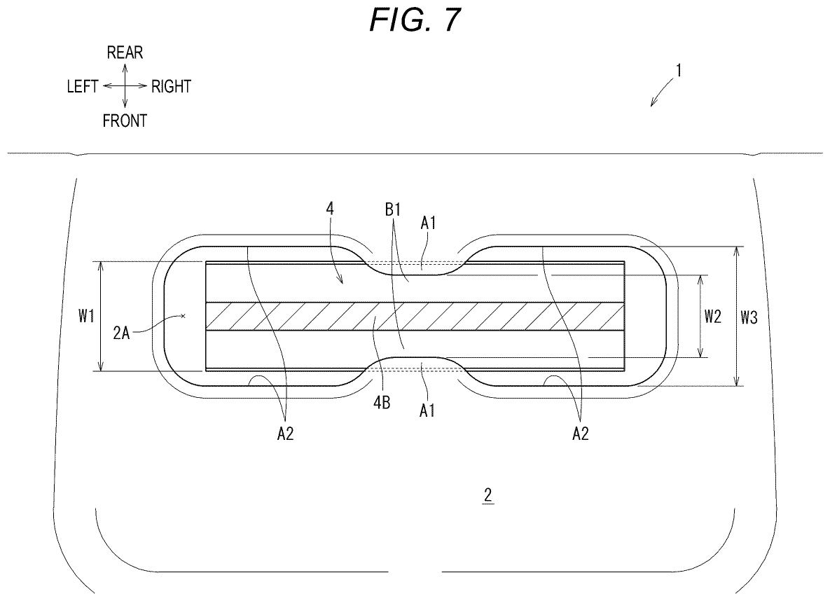

Next, the configuration of the cushion body 1 according to a third embodiment of the present invention will be described with reference to FIG. 7. In the present embodiment, one protruding groove wall A1 is formed on each groove wall of the fastening groove 2A. The protruding groove walls A1 are formed at the positions (the positions where the arrangement in the groove length direction overlaps) facing each other in the groove width direction.

In this way, even in a configuration in which only one protruding groove wall A1 is formed in each groove wall, the fastener 4 can be fixed so as to be pressed and sandwiched in the groove width direction by the protruding groove walls A1. Since the configurations other than the above are the same as the configuration disclosed in the first embodiment, the same reference numerals are given and the detailed description thereof is omitted.

### Fourth Embodiment

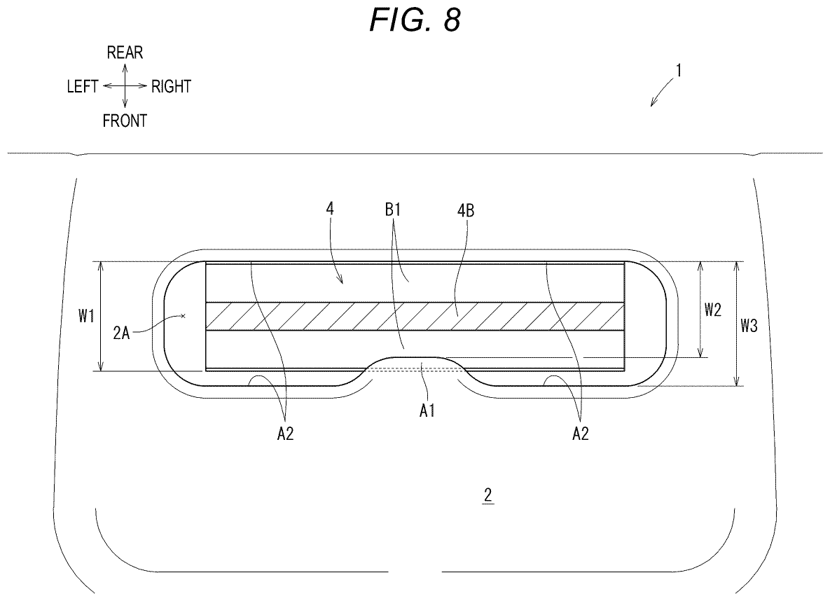

Next, the configuration of the cushion body 1 according to a fourth embodiment of the present invention will be described with reference to FIG. 8. In the present embodiment, one protruding groove wall A1 is formed only on one groove wall of the fastening groove 2A, and no protruding groove wall A1 is formed on the other groove wall (only the recessed groove wall A2 is formed).

The fastener 4 comes into contact only with the protruding groove wall A1 on one groove wall on which the protruding groove wall A1 is formed, and comes into contact with the entire region in the groove length direction on the other groove wall on which the protruding groove wall A1 is not formed. With such a configuration, the contact area between the fastener 4 and the one groove wall on which the protruding groove wall A1 is formed can also be reduced, and thus the press-fit load can also be reduced.

In the present embodiment, since the protruding groove wall A1 is provided only on one groove wall, the minimum groove width W2 that is reduced by the protrusion of the protruding groove wall A1 of the fastening groove 2A is the dimension between the inner surface of the protruding groove wall A1 and the recessed groove wall A2 facing the protruding groove wall A1. Since the configurations other than the above are the same as the configuration disclosed in the first embodiment, the same reference numerals are given and the detailed description thereof is omitted.

### Other Embodiments

The embodiments according to the present invention have been described with reference to four embodiments, whereas the present invention can be implemented in various forms other than the above embodiments.
1. The cushion body according to the present invention can be applied not only to the automobile seat, but also to the seats of the vehicles other than the automobile, such as the train seat. The cushion body can also be applied to the seats used in the vehicles other than the automobile, such as the aircraft and the ship.

In addition to the seats provided for the vehicles, the cushion body can also be applied to the seats provided in various facilities such as the sports facilities, the theaters, the concert halls, and the event venues, the massage seats, and the like. The cushion body can also be applied to the seat back in addition to the seat cushion.
2. The protruding groove wall may protrude so as to form the press-fit surface of the fastener, and may protrude in a rectangular column or may have a semicircular, triangular, or trapezoidal cross section that tapers toward the inside of the groove. In addition, the protruding groove wall may protrude in any shape, such as a shape in which the surface at the protruding end is curved in a wavy manner in the groove length direction.

The protruding groove walls may be provided in the number or arrangement other than the pattern described in the above embodiments. For example, a plurality of protruding groove walls may be aligned only on one groove wall in the groove length direction. Three or more protruding groove walls may be provided on the groove walls or on one groove wall depending on the length of the fastening groove or fastener. When a plurality of protruding groove walls are provided, the shapes and sizes of the protruding groove walls may not necessarily be the same as each other.

What is claimed is:

1. A cushion body including a seat pad and a seat cover that covers the seat pad, the cushion body comprising:
a fastening groove that is formed on a pad back surface of the seat pad, and
a fastener that is sewn to an end of the seat cover and that is press-fitted into the fastening groove,
wherein a groove wall of the fastening groove includes a protruding groove wall that protrudes so as to form a press-fit surface of the fastener, and a recessed groove wall that is aligned with the protruding groove wall in a groove length direction and that is recessed so as to avoid abutting against the fastener.

2. The cushion body according to claim 1,
wherein a plurality of the protruding groove walls are provided in the groove length direction.

3. The cushion body according to claim 1,
wherein the protruding groove walls are provided on both of the groove walls of the fastening groove.

4. The cushion body according to claim 3,
wherein the protruding groove walls are provided at facing positions of both of the groove walls.

5. The cushion body according to claim 3,
wherein the protruding groove walls provided on both of the groove walls do not overlap each other in the groove length direction.

6. The cushion body according to claim 1,
wherein a cross-sectional width of the fastener press-fitted into the fastening groove is larger than a minimum groove width for press-fitting that is reduced by a protrusion of the protruding groove wall of the fastening groove, and is smaller than a maximum groove width that is increased by a recess of the recessed groove wall.

7. The cushion body according to claim 6,
wherein the fastener includes, along a press-fitting direction, a plurality of arrowhead-shaped barbs that are hooked on the protruding groove wall by press-fitting into the fastening groove.

8. The cushion body according to claim 2,
wherein the protruding groove walls are provided on both of the groove walls of the fastening groove.

9. The cushion body according to claim 2,
wherein a cross-sectional width of the fastener press-fitted into the fastening groove is larger than a minimum groove width for press-fitting that is reduced by a protrusion of the protruding groove wall of the fastening groove, and is smaller than a maximum groove width that is increased by a recess of the recessed groove wall.

10. A cushion body comprising:
a seat pad that includes a fastening groove on a pad back surface of the seat pad; and
a seat cover that is configured to cover the seat pad; and
a fastener that is sewn to an end of the seat cover and configured to be press-fitted into the fastening groove,
wherein a groove wall of the fastening groove includes a protruding groove wall that protrudes so as to form a press-fit surface of the fastener, and a recessed groove wall that is aligned with the protruding groove wall in a groove length direction and that is recessed so as not to abut against the fastener.
